(19) United States
(12) Patent Application Publication
(10) Pub. No.: US 2023/0135082 A1
(43) Pub. Date: May 4, 2023

(54) UNDERCARRIAGE FOR A WORK MACHINE

(71) Applicant: LIEBHERR-WERK NENZING GMBH, Nenzing (AT)

(72) Inventors: Walter MIETSCHNIG, Brand (AT); Richard TORGHELE, Bartholomaeberg (AT); Robert BARGEHR, Buers (AT)

(21) Appl. No.: 17/905,621

(22) PCT Filed: Feb. 26, 2021
(86) PCT No.: PCT/EP2021/054864

§ 371 Date: Sep. 2, 2022

(30) Foreign Application Priority Data
Mar. 2, 2020 (DE) 20 2020 101 133.2

(51) Int. Cl. B62D 55/084

(52) U.S. Cl. CPC B62D 55/084

(57) ABSTRACT

The invention relates to an undercarriage for a work machine, in particular a crawler crane, having a frame central part (for receiving a superstructure of the work machine), an elongate strut element which can be mounted on the frame central part, and a crawler support for supporting a crawler chain, wherein the crawler support has a recess for the passage of the strut element, and the strut element along its longitudinal direction has a plurality of spaced-apart locking elements for fixing the crawler support at different longitudinal positions of the strut element.

### TECHNICAL FIELD

The present invention relates to an undercarriage for a work machine, in particular for a crawler vehicle such as a crawler crane.

### BACKGROUND AND SUMMARY

Crawler vehicles as a rule stand on their own crawlers during the performance of their work. This brings about the advantage with crawler cranes, for example, that they do not require any support and remain travelable despite a raised load. The length of the crawlers and the mutual spacing of the crawler assemblies, that is the crawler carrier spanned with a crawler chain, are essential parameters for the determination of the crane tilting edges during the crane deployment.

The tilt stability admittedly increases as the spacing between the crawler assemblies increases; however, the increase simultaneously produces a disadvantageous impairment of the travel width of the crawler crane. A large travel width is, on the one hand, disruptive with respect to the required clearance width between disruptive edges and, on the other hand, a wider track necessarily has to be provided to be able to travel the vehicle provided with crawlers on a construction site without risk. The rated capacity of the ground in particular has to be ensured to take up the ground pressure caused by the crawlers. As a rule, a compacting of the ground is necessary for this purpose. The different objectives of crane stability and required travel width therefore often have to be weighed against one another to make a suitable decision as to which configuration is better suited for the present deployment.

It is therefore advantageous to allow a variable track width that is selected in dependence on the specific deployment environment. This variability is, however, obtained with disadvantages in the prior art since different undercarriages are kept available to change the track width or, e.g. as in EP 0 590 123 B1, the crawler assemblies are adjusted via parallelogram connecting rods attached to the center frame part of the crawler chassis.

The keeping available of a plurality of different undercarriages for different track widths represents a challenging logistical effort and also always requires an extensive rebuild on the adjustment of the track.

The mechanisms further known from the prior art for the adjustment of the track such as the provision of parallelogram connecting rods at the center frame part of the undercarriage result in a considerable weight increase of the center frame part so that on a dismantling of the crawler assemblies that typically has to be provided for transport, the center frame part has a very high weight that makes the transport more difficult.

It is therefore the aim of the present invention to overcome the disadvantages listed above and to nevertheless provide a variable track width with as little work effort as possible.

Provision is accordingly made that the undercarriage for a work machine, in particular a crawler vehicle such as a crawler crane, comprises a center frame part to take up a superstructure of the work machine, at least one elongate strut element that can be attached to the center frame part, and at least one crawler carrier to carry a crawler chain, wherein the undercarriage is characterized in that the crawler carrier has a cutout for leading through the strut element, wherein the strut element may be led through the cutout of the crawler carrier and the strut element may have a plurality of latching elements spaced apart from one another along its longitudinal direction to fix the crawler carrier at different longitudinal positions of the strut element.

On the one hand, it is made possible by the strut element that can be attached to the center frame part that on a dismantling of the crawler assemblies, the strut element can be removed from the center frame part so that the weight and the dimensions of the center frame part are as small as possible for transport. On the other hand, the strut element led through the cutout of the crawler carrier produces a variability with respect to the desired track width of the undercarriage since the strut element has a plurality of latching elements spaced apart from one another along its longitudinal direction to fix the crawler carrier at different longitudinal positions of the strut element.

Provision can be made here that the crawler carrier and the strut element represent a common assembly and can only be separated from one another by extensive rebuild measures. Under normal circumstances, however, there may not be any separation of the strut element and the crawler carrier since the strut element is admittedly displaceably arranged in the cutout of the crawler carrier, but cannot be pulled out the cutout.

It is advantageous with the present invention that a decision on which track width the undercarriage can be made at very short notice, that is directly before an attachment of the crawler assemblies to the center frame part. A keeping available of a differently designed center frame part is no longer necessary since in accordance with the invention, the variability of the track takes place independently of a design of the center part.

Provision can be made in accordance with the invention that the plurality of latching elements that are spaced apart from one another are pin holes to receive a pin.

How deep the strut element penetrates into the cutout of the crawler carrier or how far it is pushed through the cutout can thus be set with the aid of at least one pin. The spacing of the crawler carrier from the center frame part varies in dependence on this. To implement the different fixing points or arranged at the longitudinal axis of the strut element or the latching element of the crawler carrier, pinning holes spaced apart from one another can be provided in the longitudinal direction of the strut element, for example. If a corresponding pinning hole is likewise present at the crawler carrier, a pin connection that fixes the crawler carrier to the strut element can be provided with an aligned orientation of the pin hole at the strut side with the pin hole at the carrier side by inserting a pin. It is clear here that a plurality of pinning holes or latching elements can be provided at a congruent longitudinal position of the strut element to obtain a more reliable fixing.

As already briefly explained, provision can accordingly be made that the crawler carrier has a latching element to fix the strut element introduced into the crawler carrier or led through it, with the latching element being a pin hole to receive a pin.

Provision can thus be made that the crawler carrier is fixed to the strut element by means of a pin connection, such as by the aligned orientation of pinning holes that correspond to one another at the strut element and at the crawler carrier and the inserting of a pin into the mutually aligned pinning holes.

Provision can be made in accordance with a modification of the invention that the strut element has a positioning cam that projects outwardly from the strut element to align the crawler carrier at a preferred fixing position, for instance, with the positioning cam projecting perpendicular to the longitudinal direction of the strut element.

This positioning cam can here cooperate with a front side of the cutout, can abut it, for example, so that it is thereby indicated that one of the plurality of fixing positions of the crawler carrier at the strut element has been reached.

Provision can furthermore be made that the crawler carrier comprises a claw-like recess, that extends in parallel with the direction of introduction or leading through of the strut element, for receiving a positioning cam projecting from the strut element to align the crawler carrier at a preferred fixing position of the strut element in the peripheral region of the cutout for leading through or introducing the strut element, for instance, with at least one claw-like recess being provided at both sides of the cutout in the peripheral region.

If the positioning cam of the strut element now cooperates with a recess provided at the front-side peripheral edge of the cutout, it can lead to a correct alignment of the strut element in the cutout or can contribute to a correct centration of the strut element in the cutout. The recess provided at the front side can here extend in parallel with the longitudinal direction of the strut element inserted into the mount. In other words, the recess in the front edge of the cutout can extend perpendicular to the longitudinal direction of the crawler carrier so that the claw-like recess can produce an aligning effect, for example a centration of the strut element in the cutout, in cooperation with the positioning cam.

Provision can be made here that at least one recess is provided at each of the two front sides of the cutout, for instance so that two recesses are provided at each of the front sides and cooperate with corresponding positioning cams of the strut elements. If two or more claw-like recesses are provided at one of the two front sides, they can be arranged at oppositely disposed sides (top and bottom or left and right) of the front side surrounding the strut element.

Provision can furthermore be made in accordance with the invention that the center frame part has a claw-like, approximately semicircular capturing surface for receiving a transverse pin of the strut element for the attachment of the strut element and may have an associated pin hole to produce a rigid connection of the strut element and the center frame part to an aligned pin hole at the strut side via a pin connection.

A transverse pin that is adapted to cooperate with a capturing surface of the center frame part can accordingly be present that is arranged transversely to the longitudinal direction of the strut element at a longitudinal end region.

The strut element to be attached can initially be placed on the center frame part with the aid of the capturing surface via a relative movement and can be prepositioned without an exact alignment of the strut element being necessary for this. The possibility thus results of first placing the strut element with a transverse pin projecting from the strut element on the center frame part and only then to align it in an assembly position so that the connection elements can typically be set in the form of pins and the final connection of the strut element to the center frame part can be established.

This produces a substantially faster and simplified attachment of the strut element to the center frame part. Care in particular thus only has to be taken that the transverse pin of the strut element and the capturing surface of the center frame part are positioned with respect to one another such that they engage into one another. If this is the case, only a pivot movement of the two components with respect to one another is possible.

Provision can thus be made in accordance with the invention that a rigid connection of the strut element and the center frame part takes place after placing a transverse pin into the capturing surface and a corresponding pivot movement of the strut element placed into the capturing surface that serves the aligned orientation of the pin holes present at the strut side and the frame side. Once an aligned arrangement of the two pin holes has been achieved, the connection of the strut element and the center frame part can be fixed by the automatic or manual insertion of a pin.

In accordance with a modification of the invention, the strut element is pushed into the leadthrough of the crawler carrier and the spacing of the crawler carrier from the center frame part, that is the track width of the work machine, is variable, in particular variable by steps, due to the plurality of latching elements of the strut element spaced apart from one another in the longitudinal direction.

Provision is made in accordance with the invention that the strut element is pushed into the crawler carrier such that a sliding out of the strut element is also not possible with an inserted pin. A common assembly of crawler carrier and strut element that can be attached to the center frame part is thus therefore provided that can nevertheless effect a variable track width.

Since a sliding of the strut element out of the cutout of the crawler carrier is not possible, the crawler carrier can be raised, for example using an auxiliary crane, and can be attached to the center frame part. Additional measures against a slipping of the strut element out of the cutout do not have to be made here.

In accordance with a further embodiment, the strut element can have at least three mutually spaced apart latching elements along its longitudinal direction to fix the crawler carrier at different longitudinal positions of the strut element. The crawler carrier can thus be attached to the strut element at more than two positions so that a greater variability with respect to the travel width results.

Provision can furthermore be made that a plurality of strut elements, such as two or four strut elements, are provided that can be attached to the center front part, and wherein each of the plurality of strut elements cooperates with a cutout of a crawler carrier.

A plurality of strut elements, of which each can be attached to the center frame part, can accordingly also be provided at strut elements in accordance with the invention. In addition, a plurality of strut elements can also cooperate with a common crawler carrier so that, for example, two strut elements extend to one and the same crawler carrier or are inserted into cutouts of the crawler carrier provided for this purpose. A separate cutout is provided in the crawler carrier here for every strut element that cooperates with the crawler carrier.

A typical configuration here is the presence of four strut elements of which two respective ones cooperate with a first crawler carrier and the other two cooperate with a second crawler carrier. The strut elements can be identical in this respect.

In addition, provision can be made in accordance with the invention that the center frame part has a substantially parallelepiped-shaped basic design and is configured at two of its oppositely disposed sides to attach at least one or two, strut elements in each case that cooperates/cooperate with one/a respective cutout of the crawler carrier.

Provision can be made in accordance with the invention that the strut element is a steel girder that may have a rectangular cross-section in its basic shape.

The invention further relates to a work machine, in particular to a crawler crane, having an undercarriage.

### BRIEF DESCRIPTION OF THE FIGURES

Further features and details of the present invention will become clear on the basis of the following description of the Figures. There are shown:

FIG. 1a: a perspective representation of an undercarriage in accordance with the invention with crawler chains;

FIG. 1b: a perspective representation of the center frame part;

FIG. 1c: a perspective representation of the crawler carrier with a crawler chain;

FIG. 2a the center frame part from the front;

FIG. 2b: the center frame part in a side view;

FIG. 2c: the center frame part in a plan view;

FIG. 3a: an enlarged perspective representation of the crawler carrier with a crawler chain;

FIG. 3b: a perspective representation of the crawler carrier without a crawler chain;

FIG. 3c: a view of the crawler carrier without a crawler chain obliquely from below;

FIGS. 4a-h: plan views and perspective representations of two different fixing positions of the crawler carrier in a respective latched and unlatched state;

FIGS. 4j-k: sectional views of the strut element to illustrate the unlatched and latched state with the crawler carrier; and

FIGS. 5a-c: different frontal views during the attachment of a strut element to the center frame part.

### DETAILED DESCRIPTION

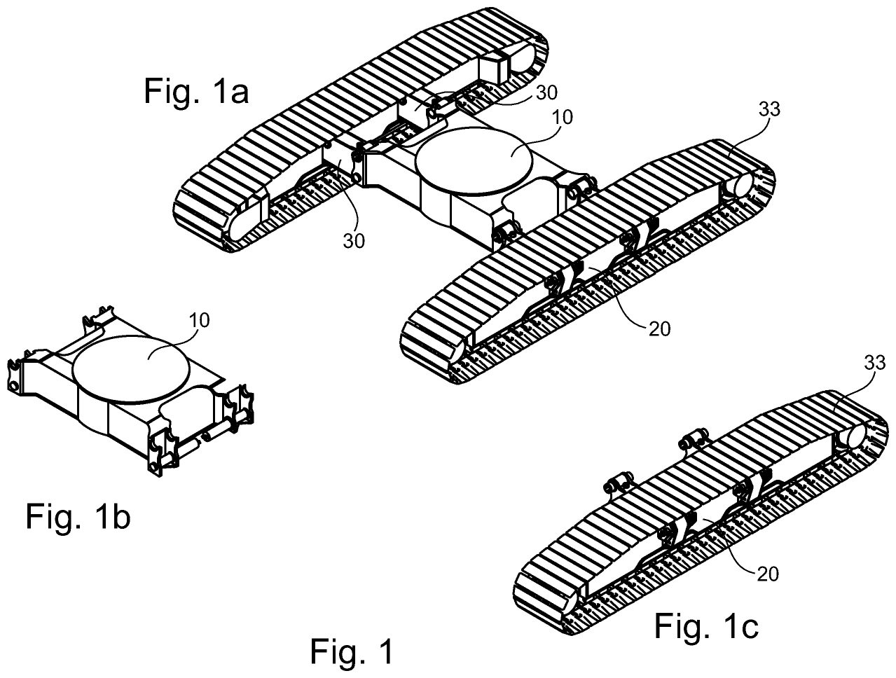

FIG. 1a shows the undercarriage in an assembled state. It can be recognized that a plurality of strut elements 30 are attached to the center frame part 10 that are connected to a crawler carrier 20 at the left side and at a right side. In this respect, each of the two crawler carriers 20 is provided with two cutouts for the respective introduction or leading through of a strut element 30. In addition, the crawler chain 33 is shown that is spanned on the crawler carrier.

The approximately parallelepiped shape of the center frame part can be recognized in FIG. 1b in which a respective two connection devices for attachment of a strut element are provided at two oppositely disposed side edges.

Each of the connection devices has a claw-like, approximately semicircular capturing surface for receiving a transverse pin of the strut element and furthermore has a pin hole arranged below the capturing surface. As further shown in FIG. 1b, the pin for driving into the pin hole can come from a pin mount that can project automatically or manually from it. The pin may automatically travel out of its pin mount and fix the strut element at the center frame part on an alignment of the pin hole at the strut side with the pin hole at the frame side.

FIG. 1c shows a crawler carrier 20 with a crawler chain 33 in a perspective view.

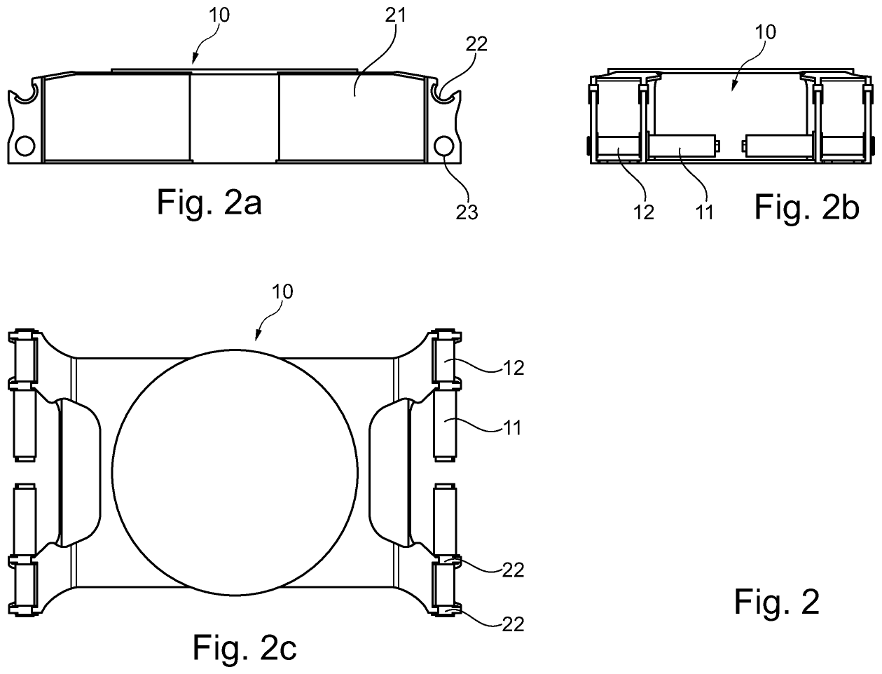

FIG. 2a is a front view of the center frame part 10 that shows the body typically produced in steel construction 21 having the connection elements for attaching a strut element 30 that are present at both sides of the center frame part 10. The capturing surface 22 can be recognized that can be configured as a claw-like, approximately semicircular capturing surface 22 to receive a transverse pin 34 of the strut element 30. The frame-side connection means for fixing the strut element 30 furthermore has a pin hole 23.

FIG. 2b is a side view of the center frame part 10 in which the pin mount 11 and the pin 12 pushed out of this pin mount 11 can be recognized. The frame-side pin 12 is accordingly shown in a latching position that is normally adopted on an aligned arrangement of the strut-side pin holes and the frame-side pin holes 23.

FIG. 2c is a plan view of the center frame part 10 in which the capturing surface 22 for placing on a transverse pin of the strut element can be recognized. The frame-side pin 12 and the associated pin mount 11 are again arranged below this capturing surface here.

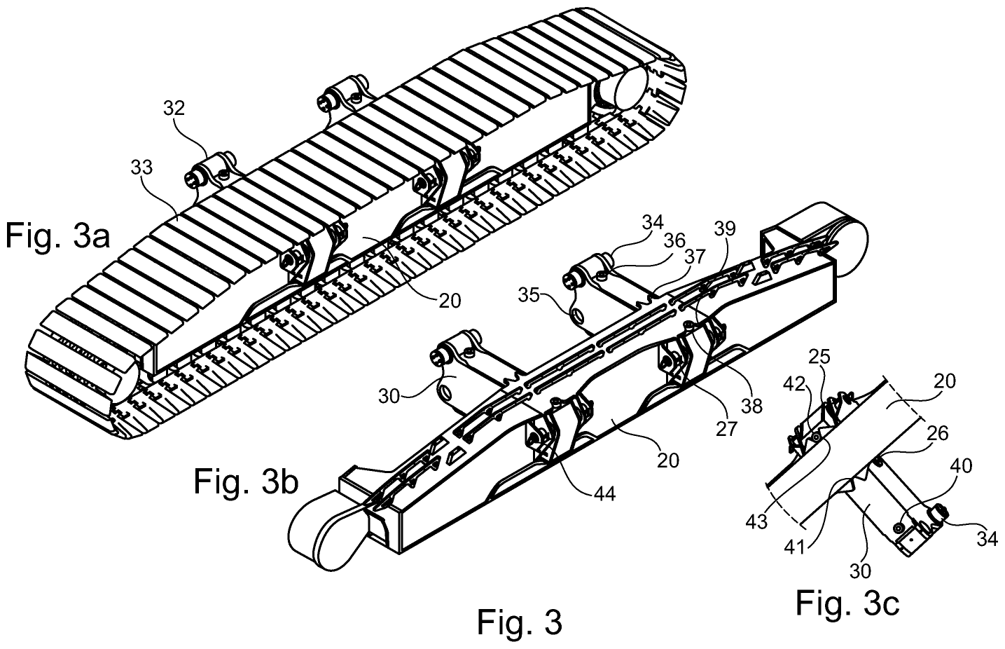

FIG. 3a shows the crawler carrier 20 with the peripherally arranged crawler chain 33. Two cutouts into which respective strut elements 30 are inserted and that are spaced apart in the longitudinal direction of the crawler carrier 20 are present transversely to a longitudinal direction of the crawler carrier 20. The strut elements are fastened at their longitudinal ends remote from the center frame to the crawler carrier by a pin connection. The other longitudinal end of the strut elements, that is the longitudinal end facing the center frame part 10, has a connection means 32 here for a rigid connection to the center frame part 10.

FIG. 3b allows a better view of the crawler carrier 20 obliquely from above since the crawler chain 33 is now no longer shown. The rigid connection of the crawler carrier 20 and the strut element 30 is in this respect secured by a pin connection, with a pin 44 being guided through a carrier-side pin hole and a strut-side pin hole so that no relative movement can occur between the strut element 30 and the crawler carrier 20. To achieve a correct alignment of the strut element in the cutout or leadthrough 24 of the crawler carrier 20, at least one outwardly projecting positioning cam 36, 38, 40, 42 can be arranged at the strut element 30 and cooperates with a contour 37, 39, 41, 43 of the cutout 24 or of the leadthrough 24 of the crawler carrier. As shown in FIG. 3b, this contour 37, 39, 41, 43 is an approximately V-shaped recess or also a claw-like recess in the front side of the cutout 24, with the recess extending in a direction that is arranged transversely to the longitudinal direction of the crawler carrier 20 and is thus therefore in parallel with the insertion direction of the strut element 30 into the cutout 24. It can be recognized with respect to the two strut elements 30 that the positioning cam 38 remote from the center frame part 10 and arranged at the top is offset in the longitudinal direction of the strut element 30 from a positioning cam 36 offset from the center frame part and likewise arranged at the top. If a positioning cam 36, 38, 40, 42 comes into engagement with the associated contour 37, 39, 41, 43 arranged on the front side of the cutout 24, a further relative movement of the strut element 30 and the crawler carrier 20 is prevented since the positioning cam 36, 38, 40, 42 and the contour 37, 39, 41, 43 serve as an abutment. Once an abutment position has been reached, the pin holes 27 present at the carrier side are also aligned with the respective associated struts-side pin holes 25, 27 so that an automatic or manual pinning can also take place in a simple manner.

FIG. 3c, in contrast to FIG. 3b, shows a lower side of the arrangement of the crawler carrier 20 and the strut element 30. Positioning cams 40, 42 that are configured to cooperate with different front sides of the cutout or leadthrough 24 of the crawler carrier 20 and that are spaced apart in the longitudinal direction are also arranged on the lower side of the strut element. Exactly like the positioning cams 36, 38 arranged on the upper side of the strut element 30, a position of the crawler carrier and the strut element 30 is fixed on an engagement with the approximately V-shaped or also claw-like recess 41, 43 in the front side of the leadthrough 24, in which position the one pair of the pin holes 27 present on the carrier side is aligned with the respective associated strut-side pin holes 25, 26. The cooperation of the contour 41, 43 with the positioning cam 40, 42 also effects an optimum alignment of the strut element 30 here with respect to the crawler carrier or the leadthrough 24.

The positioning cams 36, 38, 40, 42 are furthermore suitable to prevent a complete release of the strut element 30 from the crawler carrier 20. A slipping through or a sliding out of the strut element 30 cannot take place when positioning cams 36, 38, 40, 42 are present since a pair of positioning cams previously comes into engagement with the associated contour arranged at the front side of the leadthrough 24. It is clear to the skilled person that a specially shaped contour is not necessarily required at the front sides of the cutout to effect a positioning of the strut element 30 and the crawler carrier 20. It is only necessary that at least one of the positioning cams comes into contact with the front side of the leadthrough 24.

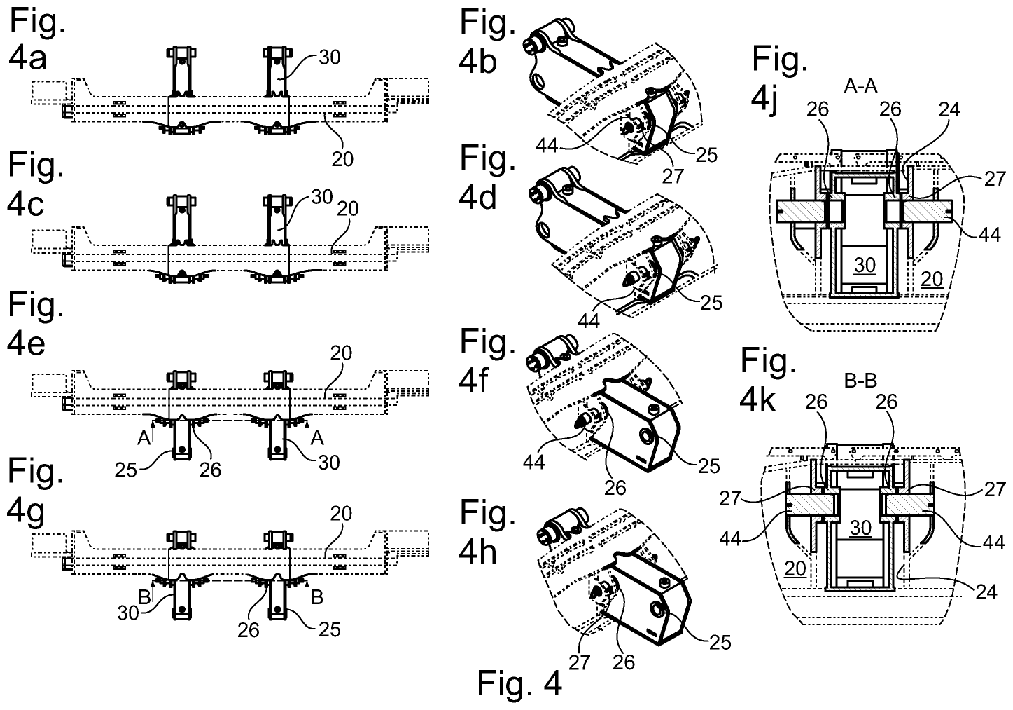

FIGS. 4a-h show plan views and perspective representations of two different fixing positions of the crawler carrier 20 in a respective latched and unlatched state.

FIG. 4a shows in a plan view the crawler carrier 20 shown by a dashed line and the strut element 30 aligned transversely thereto and pushed through the (non-recognizable) leadthrough 24. If the strut elements 30 are now attached to the center frame part in such a configuration, the track of the undercarriage would be broadened.

FIG. 4b shows a perspective view of FIG. 4a, in which it can be recognized that the pin 44 is in its pushed-in state, that is connects the crawler carrier 20 and the strut element 30 to one another.

FIGS. 4c and 4d substantially correspond to FIGS. 4a and 4b, but with the pin 44 now no longer being in a latched position, but rather in an unlatched position. The pin is now pulled out of the strut-side pin hole 25 with respect to its previous position. A displacement of the strut element 30 in the leadthrough 24 of the crawler carrier 20 is now possible.

FIGS. 4e and 4h now show a plan view or a perspective representation in which the two strut elements 30 have been respectively pushed further through the leadthrough of the crawler carrier from their positions adopted in FIGS. 4a-4d. This state corresponds to a reduced track width of the undercarriage since on an attachment of the strut elements 30 arranged in the crawler carrier in this manner, the crawler carrier is closer to the center frame part.

FIGS. 4e and 4f here show the pin connection in an opened state, whereas FIGS. 4g and 4h show pushed in pins 44 that also cooperate with a respective strut element 30.

The crawler carrier can therefore be arranged at two different longitudinal positions of a respective strut element 30, which can be implemented by the provision of a plurality of pin holes 25, 26 or pin hole pairs at the strut side and spaced apart in the longitudinal direction of the strut.

FIGS. 4j and 4k show a sectional view in the pin connection from FIGS. 4e and 4g, that is in an unlatched (FIG. 4) and a latched (FIG. 4k) state. In an unlatched state, the pin 44 does not engage into a strut-side pin hole 26. The situation is different in the latched state in which the pin 44 engages into the associated pin hole 26 of the strut element 30. It can furthermore be seen that a respective pin 44 can be provided at oppositely disposed sides, with this naturally not having to be the case. One pin 44 would also be sufficient for the basic principle of the invention.

It can be recognized overall that its spacing with respect to the center frame part can be arranged in a simple manner.

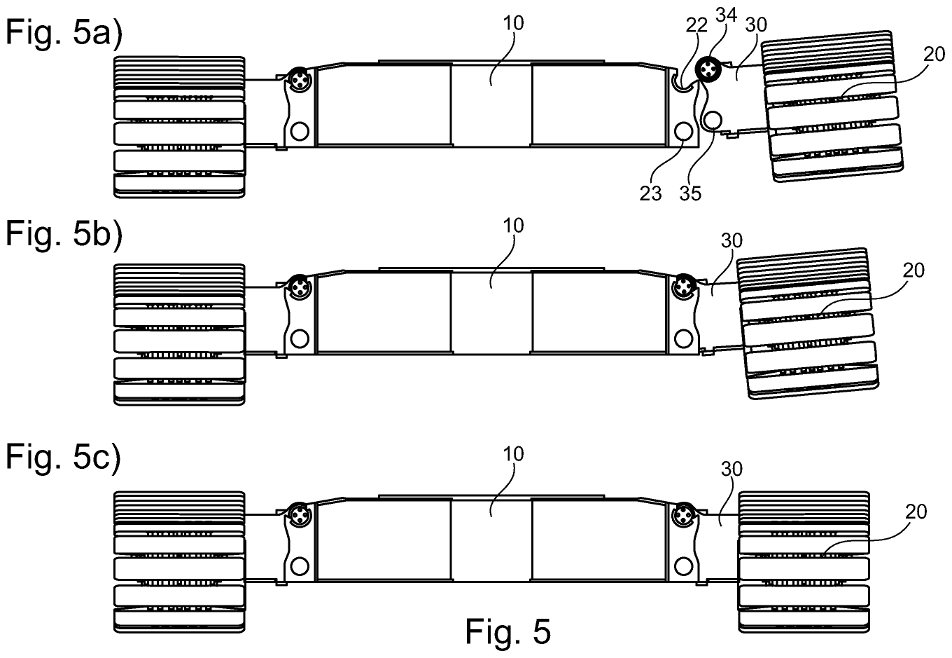

FIGS. 5a-5c show an attachment procedure of the strut element 30 fixed at the crawler carrier to the center frame part 10. The crawler carrier 20 is hooked via the strut-side transverse pins 34 into the upwardly open mounts 22 (that can also be called capturing surfaces) via the strut-side transverse pins by means of auxiliary lifting equipment such as a crane or the like. The crawler carrier 20 connected to the strut element 30 is thereby seated on the center frame part 10 and a first (horizontal) connection axis is formed about which the crawler carrier 20 is pivoted to reach the final assembly position after the first pre-positioning.

As shown in FIG. 5a, the crawler carrier 20 can also be inclined in the direction of the center frame part for a simpler assembly (cf. FIG. 5a). Finally, a pivoting of the crawler carrier 20 toward the center frame part 10 takes place due to gravity about the first connection axis produced by the transverse pin 34 and the capturing surface 22.

Once the assembly position has been reached, that is an aligned orientation of the strut-side pin hole 35 and of the frame-side pin hole 23, an automatic or manual pinning takes place via the pin 11 (cf. FIG. 2b) so that a second (likewise horizontal) connectionH axis is established and the crawler carrier 20 is now finally fastened to the center frame part 10. Provision can be made here that the crawler carrier 20 is simultaneously fully automatically connected to the energy supply of the work machine 1 and is immediately ready for operation.

FIGS. 1-5 are drawn to scale, although other relative dimensions may be used, if desired. In all the embodiments, the described connection elements of strut element, center frame pat, and crawler carrier can also be arranged at the respective other connection partner, with the previously described assembly or the properties presented above not being changed.

Provision can thus be made, for example, that the capturing surface 22 is not arranged at the center frame part 10, but rather at the strut element 30 and a transverse pin is instead provided at the center frame part 10.

1. An undercarriage for a work machine, comprising:
a center frame part for receiving a superstructure of the work machine;
an elongate strut element that is attachable to the center frame part; and
a crawler carrier for carrying a crawler chain,
wherein
the crawler carrier has a cutout for leading through the strut element; and
the strut element has a plurality of mutually spaced apart latching elements along its longitudinal direction to fix the crawler carrier at different longitudinal positions of the strut element.

2. The undercarriage in accordance with claim 1, wherein the plurality of mutually spaced apart latching elements are pin holes to receive a pin.

3. The undercarriage in accordance with claim 1, wherein the crawler carrier has a latching element to fix the strut element introduced into the crawler carrier or led through it.

4. The undercarriage in accordance with claim 1, wherein the crawler carrier is fixed to the strut element by means of a pin connection.

5. The undercarriage in accordance with claim 1, wherein the strut element has a positioning cam that projects outwardly from the strut element to align the crawler carrier at a fixing position.

6. The undercarriage in accordance with claim 1, wherein the crawler carrier comprises a claw-like recess that extends in parallel with the direction of introduction or leading through of the strut element, for receiving a positioning cam projecting from the strut element to align the crawler carrier at a preferred fixing position of the strut element in the peripheral region of the cutout for leading through or introducing the strut element.

7. The undercarriage in accordance with claim 2, wherein the center frame part has a claw-like, approximately semicircular capturing surface for receiving a transverse pin of the strut element for the attachment of the strut element.

8. The undercarriage in accordance with claim 7, wherein a rigid connection of the strut element and the center frame part takes place after placing the transverse pin into the capturing surface and a corresponding pivot movement of the strut element placed into the capturing surface that serves the aligned orientation of the pin holes present at the strut side and the frame side.

9. The undercarriage in accordance with claim 1, wherein the strut element is pushed into the leadthrough of the crawler carrier and the spacing of the crawler carrier from the center frame part, that is the track width of the work machine, is variable, in particular variable by steps, due to the plurality of latching elements of the strut element spaced apart from one another in the longitudinal direction.

10. The undercarriage in accordance with claim 1, wherein the strut element is pushed into the crawler carrier such that a sliding out of the strut element is also not possible with an inserted pin.

11. The undercarriage accordance with claim 1, wherein the strut element has at least three mutually spaced apart latching elements along its longitudinal direction to fix the crawler carrier at different longitudinal positions of the strut element.

12. The undercarriage in accordance with claim 1, wherein a plurality of strut elements, are provided that can be attached to the center front part, and wherein each of the plurality of strut elements cooperates with a cutout of a crawler carrier.

13. The undercarriage in accordance with claim 1, wherein the center frame part has a substantially parallelepiped-shaped basic design and is configured at two of its oppositely disposed sides to attach at least one strut elements in each case that cooperates/cooperate with one/a respective cutout of the crawler carrier.

14. A work machine, having an undercarriage in accordance with claim 1.

15. The undercarriage in accordance with claim 3, wherein the latching element of the crawler carrier is a pin hole to receive a pin.

16. The undercarriage in accordance with claim 4, wherein the crawler carrier is fixed to the strut element by the aligned orientation of pinning holes that correspond to one another at the strut element and at the crawler carrier and the inserting of a pin into the mutually aligned pinning holes.

17. The undercarriage in accordance with claim 5, wherein the positioning cam is projecting perpendicular to the longitudinal direction of the strut element.

18. The undercarriage in accordance with claim 6, wherein the one claw-like recess is provided at both sides of the cutout in the peripheral region.

19. The undercarriage in accordance with claim 7, wherein the center frame part has an associated pin hole to produce a rigid connection of the strut element and the center frame part to an aligned pin hole at the strut side via a pin connection.
